(19) United States
(12) Patent Application Publication
(10) Pub. No.: US 2016/0177047 A1
(43) Pub. Date: Jun. 23, 2016

(54) POLYMER SUBSTRATE HAVING PORE ON SURFACE, AND SURFACE TREATMENT METHOD FOR POLYMER SUBSTRATE THEREOF

(71) Applicant: Chungang University Industry Academic Cooperation Foundation, Seoul (KR)

(72) Inventors: Jong Hwi LEE, Seoul (KR); Hyun Jin KIM, Incheon (KR); Byoung Soo KIM, Seoul (KR); Su Yeong AN, Gyeonggi-do (KR)

(21) Appl. No.: 14/965,634

(22) Filed: Dec. 10, 2015

(30) Foreign Application Priority Data
Dec. 18, 2014 (KR) 10-2014-0183261

(51) Int. Cl. C08J 9/26; B08B 17/06

(52) U.S. Cl. CPC C08J 9/26; B08B 17/06; C08J 2201/0462; C08J 2205/042; C08J 2325/06; C08J 2369/00; C08J 2375/04

(57) ABSTRACT

The present invention relates to a polymer substrate that contains polycrystalline pores formed on a surface thereof and a method of preparing the same by a surface treatment. The polymer of the present invention contains, on its surface, pores with a polycrystalline structure, and, thus, it exhibits hydrophobicity that accounts for a high fouling resistance. Not only that, the hydrophobicity provides the polymer substrate with the ability for mechanical adhesion in the formation of an adhesive interface, resulting in an excellent adhesive strength. Also, the method of surface treatment to prepare such a substrate is advantageous in that it can treat a large area of a surface economically while not using substances that are harmful to the human body and environment.

### CROSS-REFERENCE TO RELATED APPLICATIONS

This application claims the benefit of Korean Application No. 10-2014-0183261, filed Dec. 18, 2014. The contents of the referenced application are incorporated herein by reference.

### BACKGROUND

1. Field of the Invention

The present invention relates to a polymer substrate that contains pores formed on a surface thereof, and a method of preparing the same by a surface treatment.

2. Discussion of Related Art

Polymeric materials are easy to process, light in weight and capable of realizing a variety of properties depending on a structure thereof, and thus are being used in all industries. In particular, materials with a hydrophobic surface are highly fouling-resistant such that they can be used in a variety of fields including mobile applications such as mobile phones, digital multimedia broadcasting (DMB) devices, navigation system and the like; electronic devices such as laptop computers and personal computers; quality home appliances such as televisions and stereos; structural and finishing materials for the interior of buildings; signs; car interior materials; kitchen appliances; and bathroom materials. Therefore, there is a growing interest in polymeric materials with realized hydrophobicity.

For instance, Patent Literature 1 discloses a hydrophobic surface material composed of a polymeric material that contains a complex porous structure of micropores and nanopores, and is prepared by the formation of nanopores, through plasma etching that makes use of gas mixture containing fluorine-based gas, on the surface of a polymeric material that contains micropores; and a hydrophobic thin film that is formed on the surface of the above polymeric material. In addition, Patent Literature 2 discloses a mold for producing a polymer substrate that has a micro-/nanosized structure for the realization of a hydrophobic surface.

However, cumbersome processes, such as the formation of surface micropores prior to plasma etching, are required, or environmentally harmful substances, such as CF₄, should be used in carrying out the above techniques. Besides, an operational cost—which is incurred, for example, by plasma and lithography equipment—is high, thus limiting the feasibility of large-scale mass production.

Therefore, there is an urgent need for a method of realizing a hydrophobic polymer substrate that does not use substances harmful to the human body and environment, is simpler, more economical, and capable of large-scale mass production.

### CITATION LIST

### Patent Literature

Patent Literature 1: Korean Unexamined Patent Application Publication No. 2011-0097150

Patent Literature 2: Korean Patent No. 10-0605613

### SUMMARY OF THE INVENTION

The present invention is directed to provide a polymer substrate that has hydrophobicity realized on a surface.

The present invention is also directed to provide a method of treating a surface of a polymer substrate to prepare the above polymer substrate.

To achieve the above objectives, the present invention provides a polymer substrate with a surface structure in which pores that include a polycrystalline structure, an average diameter in the range of 50 nm to 500 μm and an average depth of 500 μm or less are formed.

Also provided by the present invention is a method of surface treatment of a polymer substrate, where the method includes bringing the first solvent, which is capable of dissolving the polymer substrate, into contact with a surface of the polymer substrate and crystallizing the first solvent.

The polymer of the present invention contains, on its surface, pores with a polycrystalline structure, and, thus, it exhibits hydrophobicity that accounts for a high fouling resistance. Not only that, the hydrophobicity provides the polymer substrate with the ability for mechanical adhesion in the formation of an adhesive interface, resulting in an excellent adhesive strength of an adherend to the substrate. Also, the method of surface treatment to prepare such a substrate is advantageous in that it can treat a large area of surface economically while not using substances that are harmful to the human body and environment.

### BRIEF DESCRIPTION OF THE DRAWINGS

FIG. 1 is a scanning electron microscopic (SEM) image of a surface of a surface-treated substrate of an example.

FIG. 2 is an SEM image of a substrate surface that has undergone solvent diffusion for 5 minutes according to another example.

FIG. 3 is an SEM image of a substrate surface that has undergone solvent diffusion for 15 minutes according to still another example.

FIG. 4 is an SEM image of a cross-section of a surface-treated substrate according to an additional example.

FIG. 5 is an SEM image of a surface of the surface-treated substrate according to the additional example.

### DETAILED DESCRIPTION OF EXEMPLARY ASPECTS

While the exemplary aspects of the present invention may be subjected to various modifications, only a few selected among the exemplary aspects will be illustrated through drawings and described in detail hereinafter.

However, there is no intention to limit the present invention to a particular aspect, and it should be understood that the scope of the present invention encompasses all modifications, equivalents or alterations made within the spirit and scope of the present invention.

In describing the present invention, it will be understood that the terms such as “contain”, “containing”, “include”, “including”, “comprise”, “comprising”, “have” and “having” specify that the features, numbers, steps, operations, elements, components and/or combinations thereof disclosed herein are present, but the terms do not preclude the possibility that one or more other features, numbers, steps, operations, elements, components and/or combinations thereof are also present in or can be introduced into the scope of the present invention.

Also, the drawings provided for the present invention may be illustrated as enlarged or reduced for the convenience of explanation.

Hereinafter, aspects of the present invention will be described in detail with reference to the accompanying drawings, like reference numerals will be used for like elements even in different drawings, and redundant descriptions thereof will be omitted.

In the present invention, “polycrystalline” refers to a cluster of crystals in which a large number of small crystals aggregate, and, as the small crystals may be oriented in different directions, there may be irregularity in the crystal form.

Also, in the present invention, “pores with a polycrystalline structure” refers to pores with a structure that is induced as a result of a removal of polycrystals. The above pores may be irregular in shape and have a large distribution in diameter with respect to an average pore diameter.

Further, in the present invention, “average pore diameter” refers to an average diameter of pores found on a surface of a polymer substrate that is observed.

In addition, in the present invention, “average pore depth” refers to an extent to which pores are formed inward with respect to a surface of a polymer substrate, and may be identical to the average depth of open pores, each of which is formed of 2 or more adjacent pores.

Further, in the present invention, “diffusion of a solvent” or “solvent diffusion” refers to the penetration of a solvent—which is in contact with a surface of a polymer substrate—into an interior of the substrate, dissolving the surface.

The present invention relates to a polymer substrate that contains pores formed on a surface thereof, and a method of preparing the same by a surface treatment.

Polymeric materials are easy to process, light in weight and capable of realizing a variety of properties depending on a structure thereof, and thus are used in all industries. Recently, in pursuit of fouling resistance of a material, there is a growing interest in polymeric materials with realized hydrophobicity, and, consequently, a variety of research on a method for realizing hydrophobicity in a polymeric material is in progress. However, techniques developed thus far require cumbersome, multistage processes or use environmentally harmful substances, such as CF₄. Moreover, when a technique such as lithography is applied, the operational cost is high, thus limiting the feasibility of large-scale mass production.

Hence, the present invention proposes a polymer substrate that contains pores formed on a surface thereof, and a method of preparing the same by a surface treatment.

The polymer substrate of the present invention contains, on its surface, pores with a polycrystalline structure, and, thus, it exhibits hydrophobicity, which accounts for a high fouling resistance. Not only that, the hydrophobicity provides the polymer substrate with the ability for mechanical adhesion in the formation of an adhesive interface, resulting in an excellent adhesive strength of an adherend to the substrate. Also, the method of surface treatment to prepare such a substrate is advantageous in that it can treat a large area of a surface economically while not using substances that are harmful to the human body and environment.

Hereinafter, the present invention will be described in detail.

The present invention provides, in an example, a polymer substrate that contains a surface structure in which pores with a polycrystalline structure are formed with an average diameter in the range of 50 nm to 500 μm and an average depth in the range of 500 μm or less.

The polymer substrate of the present invention may contain, on its surface, pores with a crystalline structure of uniform depth. Here, the average diameter of the pores may be in the range of 50 nm to 500 μm. Specifically, the average diameter may be in the range of 50 nm to 10 μm; in the range of 50 nm to 1 μm; in the range of 50 nm to 500 nm; in the range of 500 nm to 250 μm; in the range of 1 μm to 100 μm; in the range of 100 μm to 500 μm; or in the range of 5 μm to 75 μm. In addition, the average depth of the pores may be 500 μm or less, and, specifically, it may be 400 μm or less; 300 μm or less; 200 μm or less; or 100 μm or less.

In one example, scanning electron microscopy (SEM) was performed on 3 types of polymer substrate of the present invention to observe their surfaces. It was confirmed from the result that pores with an average diameter in the range of about 100 to 200 nm; in the range of about10 to 25 μm; and in the range of about 35 to 60 μm, respectively, were formed on the surface of each substrate. It could be recognized from the result that pores with a polycrystalline structure and an average diameter in the range of 50 nm to 500 μm were formed on the surface of the above polymer substrates (see Experimental Example 1).

The above polycrystalline structure may satisfy one or more of the conditions of the following Mathematical Formulae 1 and 2:

D_{d}/Dₜ≧1.5 [Mathematical Formula 1]

Dₜ/D_{w}≧1.5 [Mathematical Formula 2]

In the above Mathematical Formulae 1 and 2, Dₜ represents an average wall-to-wall distance of pores, D_{d} represents an average depth of pores, and D_{w} represents an average wall thickness of pores.

Since pores are formed, to a uniform depth, only on the surface of the substrate and not on the entire substrate, the polymer substrate of the present invention may satisfy one or more of the conditions of the above Mathematical Formulae 1 and 2.

As the ratio of the average pore depth to average wall-to-wall distance of pores and ratio of the average wall-to-wall distance of pores to average wall thickness of pores are 1.2 or more—to be specific, 1.3 or more, 1.4 or more or 1.5 or more—the aforementioned polycrystalline structure may satisfy one or more of the conditions of the above Mathematical Formulae 1 and 2.

In addition, a pore formed on the surface of the above polymer substrate may form, with 2 or more adjacent pores, an open pore in which the pores are associated with one another. To be specific, the pores formed on the surface of a polymer substrate have a polycrystalline structure that is induced by the removal of a polycrystal(s), and, thus, they may not be uniform in shape. In addition, when a polycrystal formed on the surface of a polymer substrate associates with 2 or more adjacent polycrystals, the pore that is induced as the result may have an open pore, which is a structure in which 2 or more adjacent pores are associated with one another.

Further, the polymer substrate of the present invention has a surface structure in which pores with an average diameter in the range of 50 nm to 500 μm and an average depth of 500 μm or less are formed, thus, both hydrophobicity and conditions that are suitable for strong adhesion can be realized simultaneously on the surface of the substrate.

For example, the above polymer substrate may exhibit a significantly improved adhesive strength with an adherend that contains a polymer that is the same as, or different from, the polymer that constitutes the polymer substrate, and, therefore, it may satisfy the conditions of the following Mathematical Formula 3 in an evaluation of the adhesive strength:

F_{20P}/F_{0P}≧3 [Mathematical Formula 3]

In the above Mathematical Formula 3, F_{0P} represents an average maximum value of a force that is required for a 180-degree peel-off of a polymer substrate free of surface pores, and F_{20P} represents an average maximum value of a force that is required for a 180-degree peel-off of a polymer substrate that contains surface pores with an average diameter in the range of about 10 to 25 μm.

In this case, the above polymer substrate may satisfy the conditions of the Mathematical Formula 3 by having a ratio of the above average maximum forces of 3.0 or more, specifically, 3.2 or more, 3.5 or more, 3.8 or more, 4.0 or more, 4.2 or more; 4.4 or more; or 4.5 or more.

In one example, the maximum value of the force required for the 180-degree peel-off—namely, the peel strength—of a polymer substrate of the present invention that has surface pores with an average diameter in the range of about 10 to 25 μm was measured. It was shown in the results that the peel strength related to the above polymer substrate was about 33 N, whereas the peel strength related to a polymer substrate without surface pores was about 7 N. That is, in the polymer substrate of the present invention, the adhesive strength was enhanced—by about 4.71 times—compared to the adhesive strength measured with respect to the polymer substrate without surface pores. From this, it can be recognized that physical interlocking between the substrate and the adherend is accomplished due to the pores formed on the surface of the substrate, resulting in the formation of a stronger adhesion.

It can be recognized from the above result that, since the polymer substrate of the present invention exhibits an enhanced adhesive strength with an adherend due to the polycrystalline-structured pores formed on the substrate surface, the polymer substrate of the present invention satisfies the conditions of the above Mathematical Formula 3 (see Experimental Example 3).

Also, in another example, the polymer substrate of the present invention may have enhanced hydrophobicity that may lead to an improved fouling resistance, due to the surface structure in which pores with a polycrystalline structure are formed. Specifically, the above polymer substrate may have an average contact angle of 120° or more; more specifically, 125° or more; 130° or more; 135° or more; 140° or more; or 145° or more against water.

In one example, contact angles against water of 3 types of polymer substrate of the present invention were measured. It was identified from the results that the average contact angle of each of the above 3 types of polymer substrate was about 151°, 147° and 150°, respectively. It can be recognized from the results that each of the above polymer substrates has hydrophobicity realized on the surface and, thus, exhibits an excellent fouling resistance (see Experimental Example 2).

Meanwhile, the above polymer substrate may be one or more types selected from the group consisting of a polypropylene, polyethylene copolymer, polypropylene copolymer, polytetrafluoroethylene (PTFE), polyvinylidene fluoride (PVDF), PVDF copolymer, polydimethylsiloxane (PDMS), poly(ethylene oxide) (PEO), polypropylene oxide (PPO), PEO copolymer, PPO copolymer, polyethylene terephthalate (PET), polybutylene terephthalate (PBT), poly(methyl acrylate) (PMA), poly(methyl methacrylate) (PMMA), polystyrene (PS), PS copolymer, polyvinyl chloride (PVC), polyvinylpyrrolidone (PVP), polyvinyl alcohol (PVA), poly(furfuryl alcohol) (PFA), polycarbonate (PC), polyamide, polyimide, polyurethane, polyurethane copolymer, polyether urethane, cellulose acetate; and a copolymer thereof. Specifically, the above polymer may be, but is not limited to, PC or PS.

Also, in an example, the present invention provides a method of surface treatment of a polymer substrate, where the method includes bringing a first solvent, which is capable of dissolving the polymer substrate, into contact with a surface of the polymer substrate and crystallizing the first solvent.

The method of surface treatment of a polymer substrate according to the present invention may include an operation bringing the first solvent, which can dissolve the surface of the polymer substrate, into contact with the surface of the substrate; and an operation crystallizing the first solvent after the first solvent engaged in the above-described contact diffuses for a certain amount of time, in other words, after the first solvent engaged in the contact penetrates into the interior of the substrate, dissolving the surface.

In this case, the above bringing of the first solvent into contact with the polymer substrate may be carried out under conditions that include a duration of contact in the range of 1 second to 300 minutes and a contact temperature in the range of −70 to 100° C. Specifically, the above operation may be carried out for 1 second to 300 minutes; 10 seconds to 20 minutes; 10 seconds to 5 minutes; 2 to 10 minutes; 10 to 20 minutes; or 4 to 16 minutes, in the temperature range of −70 to 100° C.; −30 to 50° C.; −10 to 20° C.; 50 to 90° C.; 0 to 30° C.; −30 to 0° C.; or −5 to 15° C.

In the above process, an average diameter of the pores formed on the surface may vary, since the extent to which the first solvent penetrates into the interior of the substrate varies depending on the duration of contact of the first solvent to the surface of the substrate; therefore, the average pore diameter can be controlled effectively by adjusting the duration of contact of the first solvent to fall within the aforementioned range of duration of contact so that both the improvement in hydrophobicity and an establishment of the conditions suitable for strong adhesion can be accomplished simultaneously on the surface of a polymer substrate.

In one example, SEM was performed on 3 types of polymer substrate to observe their surfaces, while varying the duration of contact of the first solvent to the surface of a substrate. According to the results, pores with an average diameter in the range of about 100 to 200 nm were observed on the surface of the polymer substrate that had a short actual duration of contact with the first solvent; the short actual duration of contact was because of the reduction in the temperature of the polymer substrate to or below the melting point of the first solvent prior to bringing the first solvent into contact with the surface. In contrast, the polymer substrate where the duration of contact with the first solvent was 5 minutes was observed to have pores with an average diameter in the range of about 10 to 25 μm formed on the surface, and the polymer substrate with the duration of contact of 15 minutes was observed to have pores with an average diameter in the range of about 35 to 60 μm. It can be recognized from the results that the average diameter of the pores that are formed on the substrate of a polymer substrate can be controlled by adjusting the duration of contact between the substrate surface and first solvent (see Experimental Example 1).

In addition, the aforementioned crystallizing of the first solvent refers to the process of crystallizing the first solvent that has penetrated the substrate surface to a certain depth and, at the same time, solidifying the surface—which has been previously dissolved—of the substrate, thus determining the surface structure of the polymer substrate, by reducing the temperature of the polymer substrate to or below the melting point of the first solvent.

In this case, there is no particular limitation to the method used to carry out the above process, as long as the morphology and property of the polymer substrate are not altered as a result. Specifically, the crystallization of the first solvent may be accomplished by adjusting the temperature of a polymer substrate equal to or lower than the melting point of the first solvent, before or after bringing the first solvent into contact with the substrate surface.

For example, the crystallization of 1,4-dioxane—which may be used as the first solvent—is possible as a result of the contact between the polymer substrate and a refrigerant(s) prior to bringing 1,4-dioxane into contact with the polymer substrate surface, or of the reduction in the temperature of the polymer substrate to or below the melting point of the first solvent after the contact between 1,4-dioxane and the polymer substrate.

In addition, crystals of the first solvent play a role in determining pore structure. The pore structure may be a polycrystalline structure in which a number of small crystals, which may be oriented in different directions but have uniformity in average diameter, aggregate.

Further, there is no particular limitation to the type of the first solvent as long as the selected solvent can dissolve the polymer substrate; however, specifically, a solvent whose melting point falls in the range of −30 to 90° C. may be used. For instance, the first solvent may be one or more selected from the group consisting of 1,4-dioxane, tetrahydrofuran, methylene chloride, chlorobenzene, dimethylformamide, dimethyl sulfoxide, N-methylpyrrolidone, dimethyl acetoacetate, acetonitrile and tetramethylurea; it may be specifically 1,4-dioxane.

Meanwhile, the method of surface treatment according to the present invention may further include removing the crystals of the first solvent, which are formed on the surface of the polymer substrate after crystallization, where the removal of the crystals of the first solvent may be carried out by freeze-drying at, or below, atmospheric pressure or by etching with a second solvent. Here, the etching with the second solvent refers to having the polymer substrate, which contains the crystallized first solvent on its surface, immersed in the second solvent so that only the crystals of the first solvent dissolve away. The method of surface treatment of a polymer substrate according to the present invention can remove only the crystals of the first solvent formed on the substrate, thus inducing the formation of pores that take the irregular polycrystalline structure of the first solvent, without altering or damaging the surface structure of the substrate.

In this case, there is no particular limitation to the type of the second solvent, as long as the selected solvent is a nonsolvent that is miscible with the first solvent and does not dissolve away the polymer substrate. For example, the second solvent may be one or more types selected from the group consisting of water, a C₁₋₄ alcohol and acetone; specifically, it may be isopropyl alcohol, which is a C₁₋₄ alcohol.

Further, the present invention provides, through an example, a polymer substrate as a structural and finishing material that contains a surface structure in which pores that have a polycrystalline structure, average diameter of 50 nm to 500 μm and average depth of 500 μm or less are formed.

The polymer substrate as a structural and finishing material according to the present invention has a surface structure in which pores with a polycrystalline structure and an average diameter in the range of 50 nm to 500 μm are formed, thus exhibiting hydrophobicity that leads to a high fouling resistance and excellent adhesive strength with an adherend that contains a polymer that is the same as, or different from, the polymer that constitutes the polymer substrate. Therefore, the polymer substrate of the present invention may be appropriate for use in mobile applications such as mobile phones, digital media broadcasting (DMB) devices, navigation systems and the like; electronic devices such as laptop computers and personal computers; quality home appliances such as televisions and stereos; structural and finishing materials for the interior of buildings; signs; car interior materials and the like.

Hereinafter, the present invention will be described in further detail through examples (Examples and Experimental Examples).

However, the examples below are provided to merely illustrate the present invention, and the scope of the present invention should not be limited to the examples.

### EXAMPLE 1

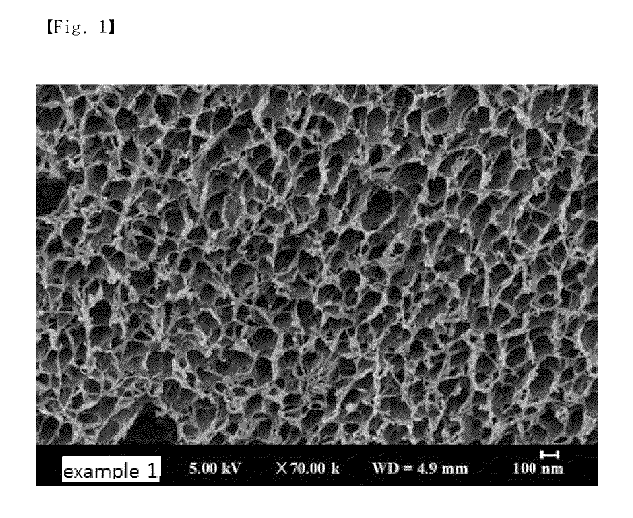

A polymer substrate (10 cm×10 cm×10 cm) that contained polystyrene (PS) was placed on a refrigerant and cooled until its temperature reached 0° C., and, when 0° C. was reached, 10 mL of 1,4-dioxane, whose temperature had been maintained at 13° C., was poured on a surface of the substrate. At this time, the surface of the above polymer substrate was dissolved by 1,4-dioxane. Subsequently, 1,4-dioxane crystallized with time due to the low temperature of the polymer substrate, thus solidifying the substrate surface once again. The above substrate, which contained the crystallized 1,4-dioxane on its surface, was immersed in 18° C. isopropyl alcohol for 3 hours for the removal of 1,4-dioxane and then dried in a room-temperature hood to obtain a polymer substrate that contained pores with a polycrystalline structure formed on the surface thereof. The structure of the pores formed as such was photographed with an SEM, and the result is provided in FIG. 1.

### EXAMPLE 2

1.5 mL of 1,4-dioxane was poured on a polymer substrate (10 cm×10 cm×10 cm) that contained polycarbonate (PC) and left for 5 minutes to dissolve the substrate surface, and then the substrate was placed in liquid nitrogen to reduce the substrate temperature rapidly. Upon completion of the recrystallization of 1,4-dioxane and solidification of the substrate surface, both of which were due to the reduction in the temperature of the polymer substrate, the above substrate was immersed in 18° C. isopropyl alcohol for 6 hours for the removal of 1,4-dioxane and then dried in a room-temperature hood to obtain a polymer substrate that contained pores with crystalline structures formed on the surface thereof.

### EXAMPLE 3

1.5 mL of 1,4-dioxane was poured on a polymer substrate (10 cm×10 cm×10 cm) that contained polycarbonate (PC) and left for 15 minutes to dissolve the substrate surface, and then the substrate was placed in liquid nitrogen to reduce the substrate temperature rapidly. Upon completion of the recrystallization of 1,4-dioxane and solidification of the substrate surface, both of which were due to the reduction in the temperature of the polymer substrate, the above substrate was immersed in 18° C. isopropyl alcohol for 6 hours for the removal of 1,4-dioxane and then dried in a room-temperature hood to obtain a polymer substrate that contained pores with polycrystalline structures formed on the surface thereof.

### EXAMPLE 4

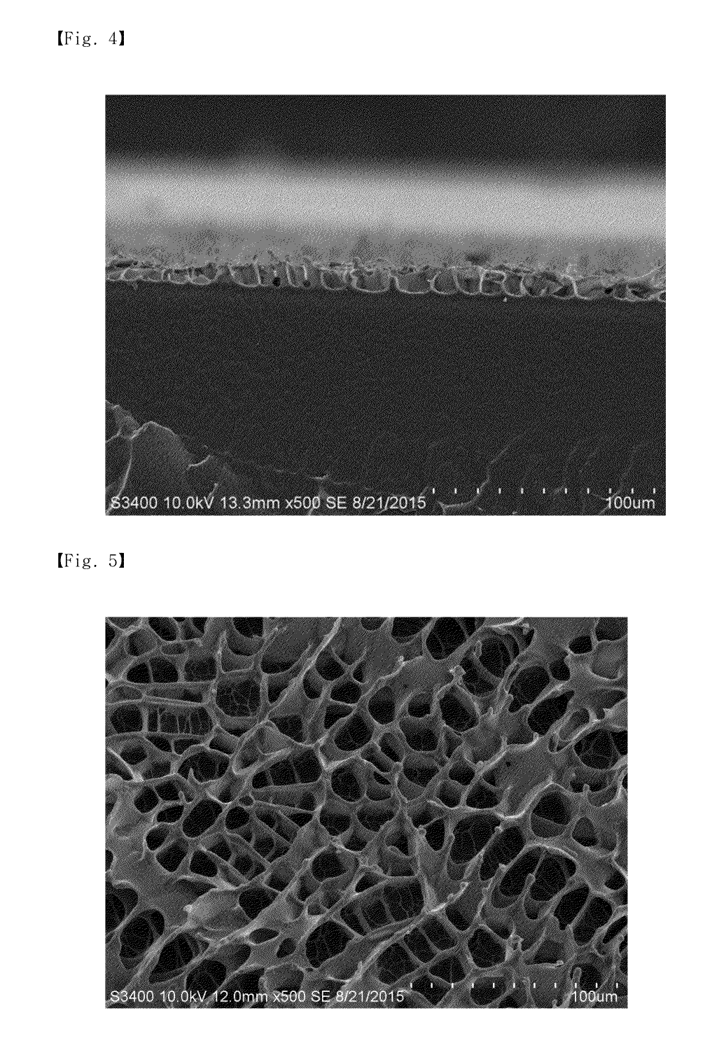

A polymer substrate (10 cm×10 cm×10 cm) that contained polyurethane (PU) was placed on a refrigerant and cooled, and, when the substrate surface temperature of 10° C. was reached, 20 mL of 1,4-dioxane, whose temperature had been maintained at 20° C., was poured on the surface thereof. At this time, the surface of the above polymer substrate was dissolved by 1,4-dioxane. Subsequently, 1,4-dioxane crystallized with time due to the low temperature of the polymer substrate, thus solidifying the substrate surface once again. The above substrate, which contained crystallized 1,4-dioxane on its surface, was immersed in 0° C. methanol for 3 hours for the removal of 1,4-dioxane and then dried in a room-temperature hood to obtain a polymer substrate that contained polycrystalline-structured pores formed on the surface thereof. The structure of the pores formed as such was photographed with an SEM, and the results are provided in FIGS. 4 and 5. As seen in FIGS. 4 and 5, the formation, on the polymer substrate surface, of a porous structural layer with the thickness in the range of 10 to 20 μm was identified, where porosity could also be observed on the surface of the layer.

### COMPARATIVE EXAMPLE 1

A polymer substrate (10 cm×10 cm×10 cm)—which was identical to the substrates used in Examples 2 and 3 —was prepared, this time without a surface treatment.

### EXPERIMENTAL EXAMPLE 1

### Evaluation of Surface Structure

The following experiment was conducted to evaluate the surface structure of the polymer substrates of the present invention.

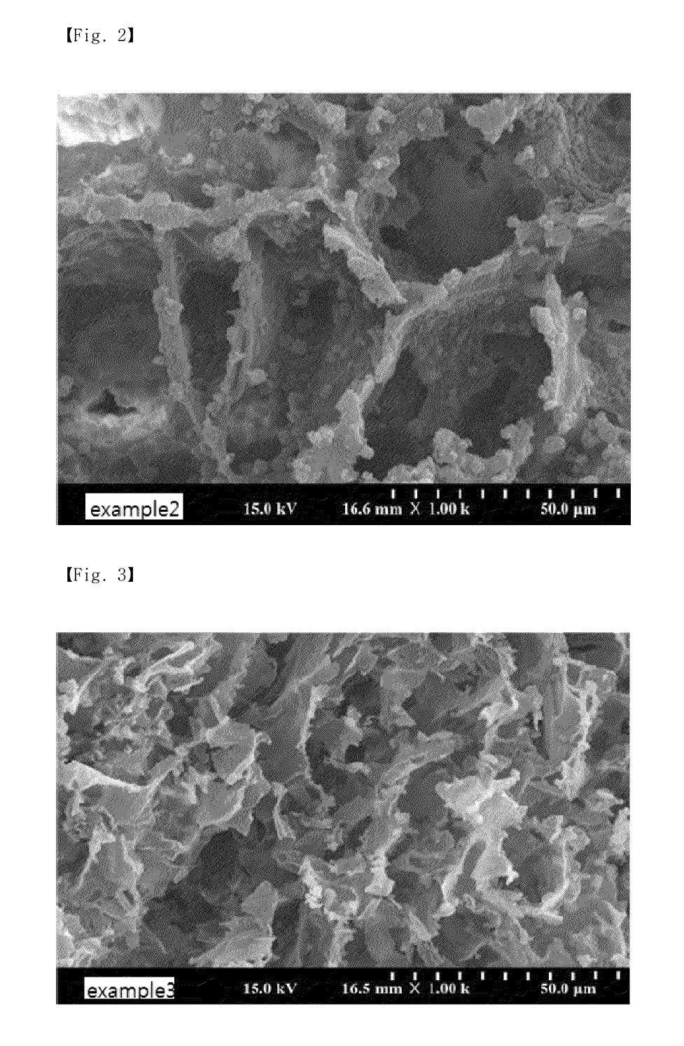

The surface of the polymer substrates that were surface-treated according to Examples 1 to 3 was photographed with an SEM, and the results are provided in FIGS. 1 to 3.

As shown in FIGS. 1 to 3, it can be recognized that the polymer substrates of the present invention contained, on the surface, polycrystalline-structured pores with an average diameter in the range of 50 nm to 500 μm.

Specifically, the polymer substrate of Example 1, which had a short duration of diffusion of 1,4-dioxane on the substrate surface—in other words, a short duration of dissolution of the substrate surface by 1,4-dioxane—due to the low temperature of the substrate, was observed to have an average diameter of surface pores in the range of about 100 to 200 nm. In contrast, pores with an average diameter in the range of about 10 to 25 μm were observed with the polymer substrate of Example 2, where the diffusion of 1,4-dioxane took place for 5 minutes, and, in the case of the polymer substrate of Example 3, where diffusion took place for 15 minutes, pores with an average diameter in the range of about 35 to 60 μm were observed on the substrate surface.

It can be recognized from such results that each of the above polymer substrates has a surface structure in which pores with a polycrystalline structure and average diameter of 50 nm to 500 μm were formed, where the average diameter of the above pores can be controlled by the duration of diffusion of 1,4-dioxane (i.e. the first solvent) on the surface of the polymer substrate.

### EXPERIMENTAL EXAMPLE 2

### Evaluation of Hydrophobicity

The hydrophobicity of the polymer substrate of the present invention was evaluated by the following experiment.

The experiment was conducted on the polymer substrates that were surface-treated according to Examples 2 and 3. Specifically, by using a contact-angle analyzer, a drop (about 10.7 μL) of water was dropped on each of the polymer substrates that were surface-treated according to Examples 1 to 3, the contact angle of the substrate against water was measured 3 times, and the measured values were averaged. In this case, the polymer substrate of Comparative Example 1, which was not surface-treated, was also analyzed for the contact angle against water, and the measured values were averaged. The results are summarized in the following Table 1.

TABLE 1

| | Average contact angle |
|---|---|
| Example 1 | 151° |
| Example 2 | 147° |
| Example 3 | 150° |
| Comparative Example 1 | 99° |

As shown in Table 1 above, it can be recognized that the polymer substrate of the present invention acquires hydrophobicity by having pores with a polycrystalline structure that are formed on the surface.

Specifically, the polymer substrates that were surface-treated according to Examples 1 to 3 were observed to have an average contact angle of 151°, 147° and 150°, respectively, against water. In contrast, the polymer substrate of Comparative Example 1, which was not surface-treated, was observed to have an average contact angle of 99° against water. In other words, it can be recognized that, by containing pores with a polycrystalline structure on the surface, each of the polymer substrates of Examples 1 to 3 had hydrophobicity that is enhanced by about 1.5 times compared to that of the polymer substrate that was not surface-treated.

It can be recognized from the above results that the polymer substrate of the present invention exhibits hydrophobicity, thus being highly fouling-resistant, by containing pores with a polycrystalline structure on the surface.

### EXPERIMENTAL EXAMPLE 3

### Evaluation of adhesive strength

The adhesive strength between the polymer substrate of the present invention and an adherend that contains a polymer (that is the same as, or different from, the polymer that constitutes the polymer substrate) was evaluated by the following experiment.

The experiment was conducted on the polymer substrates that were surface-treated according to Examples 2 and 3. Specifically, the polymer substrates surface-treated according to Examples 2 and 3 were prepared—two for each substrate—and an adhesion composition that contained dimethyldichlorosilane and a crosslinker was applied on one of each substrate and covered with the other substrate. Subsequently, curing of the adhesion composition was performed to prepare a specimen. In this case, the above polymer substrates were laminated with the surfaces containing pores facing each other.

A specimen prepared as above for measuring a peel strength—which is the maximum value of force required for a substrate to be separated from the specimen—by pulling, with a tensometer, two polymer substrates that constitute the specimen at an angle of 180° away from each other. The results are summarized in the following Table 2.

TABLE 2

| | Peel strength |
|---|---|
| Example 2 | 33 N |
| Example 3 | 27 N |
| Comparative Example 1 | 7 N |

As shown in Table 2 above, it was recognized that the polymer substrate of the present invention exhibits an excellent adhesive strength with an adherend.

Specifically, upon the 180-degree peel-off test, it was identified that peel strengths of about 33 N and 27 N were required in the polymer substrates of Examples 2 and 3, respectively. In contrast, in the polymer substrate of Comparative Example 1, a peel strength of about 7 N was required. The results indicate that a physical interlocking, which forms a stronger bonding, between the polymer substrate (that has surface pores) and the adhesion composition is achieved as the adhesion composition penetrates into, and is crosslinked inside, the pores on the surface of the polymer substrate.

It can be recognized from the above results that the polymer substrate of the present invention can form, by having pores with a polycrystalline structure on the surface, a physical interlocking during the adhesion with an adherend (that contains a polymer that is the same as, or different from, the polymer that constitutes the polymer substrate), and, therefore, the adhesive strength is significantly enhanced.

Therefore, the polymer substrate of the present invention contains surface pores with a polycrystalline structure, thus exhibiting hydrophobicity that leads to a high fouling resistance; and is capable of mechanical adhesion in the formation of an adhesive interface, thus having an excellent adhesive strength with an adherend. In addition, the method of surface treatment of the above substrate is capable of treating a large area of a surface economically while not using substances that are harmful to the human body and environment.

What is claimed is:

1. A polymer substrate comprising:
a surface structure in which pores that include a polycrystalline structure, an average diameter in the range of 50 nm to 500 μm and an average depth of 500 μm or less are formed.

2. The polymer substrate of claim 1, wherein the polycrystalline structure satisfies one or more conditions in Mathematical Formulae 1 and 2 below:
D_{d}/Dₜ≧1.5 [Mathematical Formula 1]
Dₜ/D_{w}≧1.5 [Mathematical Formula 2]
where in the Mathematical Formulae 1 and 2, Dₜ represents an average wall-to-wall distance between the pores, D_{d} represents an average depth of the pores, and D_{w} represents an average wall thickness of the pores.

3. The polymer substrate of claim 1, wherein the pores are capable of forming a structure through which the pores are associated with adjacent pores.

4. A method of surface treatment of a polymer substrate, the method comprising:
bringing a first solvent, which is capable of dissolving the polymer substrate, into contact with a surface of the polymer substrate; and
crystallizing the first solvent.

5. The method of claim 4, wherein the bringing the first solvent into contact with the surface of the polymer substrate is carried out under conditions that include a duration of contact for 1 second to 300 minutes and a temperature in the range of −70 to 100° C.

6. The method of claim 4, wherein the crystallizing the first solvent is carried out by adjusting a temperature of the polymer substrate to a temperature that is equal to or lower than a melting point of the first solvent after the bringing of the first solvent into contact with the surface of the polymer substrate.

7. The method of claim 4 further comprising:
removing crystals of the first solvent from the surface of the polymer substrate, following the crystallizing of the first solvent.

8. The method of claim 7, wherein the removing crystals of the first solvent is carried out by freeze-drying at a pressure equal to or lower than atmospheric pressure or etching by a second solvent.

9. The method of claim 4, wherein the first solvent has a melting point in the range of −30 to 90° C.

10. The method of claim 8, wherein the second solvent is miscible with the first solvent and does not dissolve the polymer substrate.
